(19) United States
(12) Patent Application Publication
(10) Pub. No.: US 2026/0270089 A1
(43) Pub. Date: Sep. 10, 2026

(54) SYSTEM AND METHOD FOR FLOW MEASUREMENT DATA TRANSFER AND VERIFICATION

(71) Applicant: Deep Fork Automation LLC, Oklahoma City, OK (US)

(72) Inventor: Robert H. Warren III, Oklahoma City, OK (US)

(21) Appl. No.: 19/559,458

(22) Filed: Mar. 6, 2026

Related U.S. Application Data
(60) Provisional application No. 63/767,799, filed on Mar. 6, 2025.

(51) Int. Cl. H04L 9/32; H04L 9/08; H04L 9/30

(52) U.S. Cl. CPC H04L 9/3252; H04L 9/0825; H04L 9/30

(57) ABSTRACT

A system and method for ensuring the integrity of flow measurement data including a flow measurement computer and a receiving computer. The flow measurement computer generates a flow measurement data set and digitally signs the flow measurement data set with a private key using a digital signature algorithm, producing a first digital signature. The flow measurement data set and signature are transmitted to a receiving computer. The receiving computer generates a second digital signature by signing the received data set with the corresponding public key. The receiving computer then compares the two signatures. If identical, the data set is verified as authentic, confirming the flow measurement data set has not been tampered with during transmission. This system enhances security and reliability in flow measurement applications, particularly in industrial settings where data accuracy is critical.

### REFERENCE TO RELATED APPLICATIONS

This application claims priority to and benefit of U.S. provisional application Ser. No. 63/767,799, filed Mar. 6, 2025, which is hereby incorporated by reference in its entirety.

### STATEMENT AS TO RIGHTS TO INVENTIONS MADE UNDER FEDERALLY SPONSORED RESEARCH AND DEVELOPMENT

Not Applicable.

### BACKGROUND ART

Hydrocarbon production and distribution typically involves a large number of custody transfers. This may occur for example at a well head, as a driller passes custody of a hydrocarbon from the well to a midstream entity. Midstream entities may pass custody to one another from one pipeline to another, or may pass custody to a downstream entity such as a refiner. These custody transfers often occur continuously and require complex flow measuring devices and computers to account for the amount of hydrocarbon transferred.

Inevitably, these transfers can result in disputes between seller (transferor) and buyer (transferee). Even small discrepancies in the flow data can result in large differences in the amount of money owed from one party to another. These discrepancies can result from human or computer modifications to the original flow data. Thus, in the field of hydrocarbon gas transfers, the American Petroleum Institute (API) has implemented API 21.1, which is an international standard specifying minimum requirements for measuring and recording the flow of gas. Among its provisions is a requirement that gas flow data must be auditable and verifiable against the original flow data on the flow measurement computer.

Contemporary attempts to comport with API 21.1 have come with significant drawbacks. Particularly, modern flow measurement systems often store and transmit flow measurement data in proprietary file types which can only be opened, viewed, and modified using proprietary software. These services are offered by only a handful of companies, resulting in prohibitively expensive software licensing fees. The result is that smaller players in oil and gas custody transfers are often at a disadvantage against the bigger, wealthier companies who can more easily afford these fees, and consequently are often less equipped to challenge flow measurement data.

It is desirable therefore to provide a system and method for flow measurement data transfer and verification by which flow measurement data is in an open source or non-proprietary format while still being verifiable against original flow measurement data stored on a flow measurement computer.

### SUMMARY OF THE INVENTION

A system and method for flow measurement data transfer and verification are disclosed. A flow measurement computer is provided which may be configured to digitally sign a flow measurement data set with a private key using a digital signature algorithm. A corresponding public key, along with the data set and digital signature, may be transmitted to a receiving computer. The receiving computer may be configured to generate a second digital signature by signing the received data set with the public key using the same digital signature algorithm. The second digital signature may be compared to the first digital signature. If the signatures are identical, the received data set may be verified as authentic. If the signatures differ, the received data set may not be verified.

The flow measurement data set provided to the receiving computer may be of an open-source format in an easily readable and editable file type. An exemplary file type may be a .txt file.

The foregoing summary provides an overview of certain selected embodiments or embodiments disclosed herein, and is not intended to describe every aspect, embodiment, embodiment, feature, or advantage of the disclosure exhaustively or comprehensively. Therefore, this summary should not be construed in such a way to limit the scope of this disclosure or to limit the scope of the claims. The details of one or more embodiments disclosed herein are set forth in the accompanying drawings and descriptions below. Other aspects, features, embodiments, and advantages will become readily apparent in view of the description, the drawings, and the claims set forth herein.

The details of one or more implementations of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. Not every component may be labeled in every drawing. Like reference numerals in the figures may represent and refer to the same or similar element or function. In the drawings:

FIG. 1 is a diagram showing an exemplary custody transfer system in accordance with the present disclosure.

FIG. 2 is a diagram showing an exemplary custody transfer system and data transmission methods in accordance with the present disclosure.

FIG. 2A is a block diagram of an exemplary embodiment of a flow measurement computer of the custody transfer system shown in FIG. 2.

FIG. 2B is a block diagram of an exemplary embodiment of a receiving computer of the custody transfer system shown in FIG. 2.

FIG. 3 is a diagram showing elements stored on a non-transitory computer readable medium of a flow measurement computer in accordance with the present disclosure.

FIG. 4 is a diagram illustrating a request to a flow measurement computer transmitted by a receiving computer in accordance with the present disclosure.

FIG. 5 is a diagram illustrating a generation of a digital signature in accordance with the present disclosure.

FIG. 6 is a diagram illustrating transmission of a data set from a flow measurement computer to a receiving computer in accordance with the present disclosure.

FIG. 7 is a diagram illustrating signing of a data set by the receiving computer in accordance with the present disclosure.

FIG. 8 is a diagram illustrating a comparison of a first digital signature and a second digital signature in accordance with the present disclosure.

FIG. 9 is a diagram illustrating an alternative data package configuration in accordance with the present disclosure.

FIG. 10A is a block diagram illustrating a digital data source, such as a flow measurement computer.

FIG. 10B is a block diagram illustrating an application for signing unsigned flow measurement data received from the flow measurement computer illustrated in FIG. 10A in accordance with the present disclosure.

FIG. 10C is a block diagram illustrating a signatory computer which houses the software application for signing as well as multiple databases for signed and unsigned flow measurement data in accordance with the present disclosure.

FIG. 11 is a flow diagram illustrating a process of signing unsigned flow measurement data and storing the signed data for long term auditing purposes in accordance with the present disclosure.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-30 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, as well as sub-ranges within the greater range, e.g., for 1-30, sub-ranges include but are not limited to 1-10, 2-15, 2-25, 3-30, 10-20, and 20-30. Reference to a range of 1-50 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, etc., up to and including 50. Reference to a series of ranges includes ranges which combine the values of the boundaries of different ranges within the series. Thus, to illustrate reference to a series of ranges, for example, a range of 1-1,000 includes, but is not limited to, 1-10, 2-15, 2-25, 3-30, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 1 mm to 10 m therefore refers to and includes all values or ranges of values, and fractions of the values and integers within said range, including for example, but not limited to, 5 mm to 9 m, 10 mm to 5 m, 10 mm to 7.5 m, 7.5 mm to 8 m, 20 mm to 6 m, 15 mm to 1 m, 31 mm to 800 cm, 50 mm to 500 mm, 4 mm to 2.8 m, and 10 cm to 150 cm. Any two values within the range of 1 mm to 10 m therefore can be used to set a lower and an upper boundary of a range in accordance with the embodiments of the present disclosure.

As used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

As used herein, “circuitry” may be analog and/or digital components, or one or more suitably programmed processors (e.g., microprocessors) and associated hardware and software, or hardwired logic. Also, “circuitry” may perform one or more functions. The term “processing component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Finally, as used herein, “software” or “application” or “algorithm” may include one or more processor executable code that when executed by one or more component (e.g., a processor) causes the component to perform a specified function. It should be understood that the software, applications, or algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, a phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

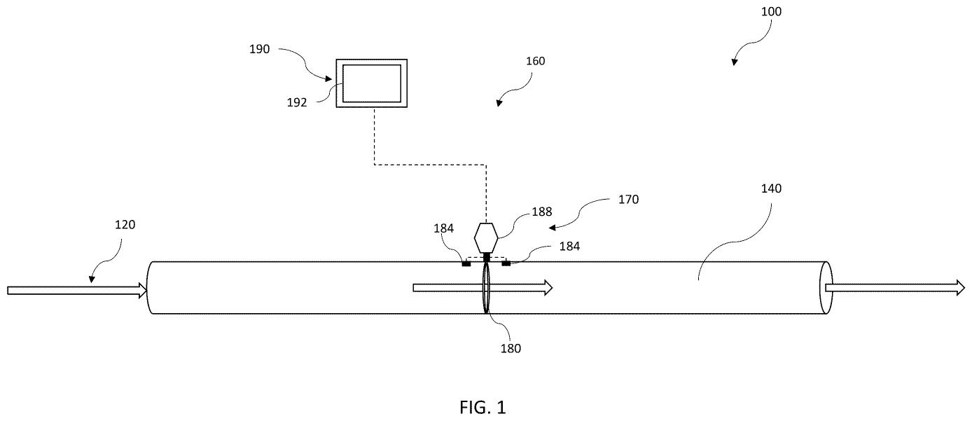

Referring now to the drawings, FIG. 1 shows an exemplary custody transfer system 100. A material 120, which may be a hydrocarbon 120 (which may be a liquid or gaseous hydrocarbon) may flow through a pipe 140. Disposed along the pipe 140 may be a flow measurement system 160. Flow measurement system 160 may comprise a flow meter 170 and flow measurement computer 190.

Flow meter 170 may be one of any kind of flow meter known to one of skill in the art for accurately measuring a volume of hydrocarbon 120 passing through a section of pipe 140 over any period of time. In some implementations, flow meter 170 may be an orifice plate flow meter. An orifice plate flow meter 170 may comprise an orifice plate 180 disposed within the pipe 140 for temporarily restricting the cross-sectional area of a flow space within the pipe 140 and causing a pressure drop of the hydrocarbon 120 passing through the space. Pressure taps 184 may be disposed on either side of the orifice plate 180 and may be fluidly communicative with a pressure sensor and transmitter 188. The pressure sensor and transmitter 188 may read a pressure differential from pressure taps 184 and determine a pressure drop of hydrocarbon 120 across orifice plate 180. The pressure sensor and transmitter 188 may be wired or in signal communication with a flow measurement computer 190. The pressure sensor and transmitter 188 may transmit a pressure drop reading across orifice plate 180 to the flow measurement computer 190.

The flow measurement computer 190, may be of any type or form known to one of skill in the art. The flow measurement computer 190 may receive raw data from the pressure sensor and transmitter 188, as well as any other sensor such as a temperature sensor, and calculate the flow rate of hydrocarbon 120 through the measured section of pipe 140.

The flow measurement computer 190 may comprise a non-transitory computer readable medium 192 for storing flow measurement data. In some implementations, the flow measurement computer 190 may store a flow measurement data set in the non-transitory computer readable medium 192. The flow measurement data set may include hourly records of flow measurement data. Hourly records of flow measurement data may be stored on the non-transitory computer readable medium 192 for any period of time such as for up to 35 days. The flow measurement data set may comprise one or more data fields holding key data points which typically change with time such as flow rate per unit of time, instantaneous flow rate, pressure differential, fluid density, temperature, and liquid/gas composition (a unique identifier associated with a specific flow meter) among others. The flow measurement data set may comprise a time-stamped series of flow rate measurements.

Non-transitory computer readable medium 192 may also store configuration data. Configuration data may comprise a set of data fields holding key data points which do not change with time such as pipe diameter, orifice size, flow meter type, sensor and meter IDs, calibration data, and the like.

Non-transitory computer readable medium 192 may also store instructions to be executed by the flow measurement computer 190 such as software for calculating flow rate of hydrocarbon 120 from raw data and software for storing and transmitting data.

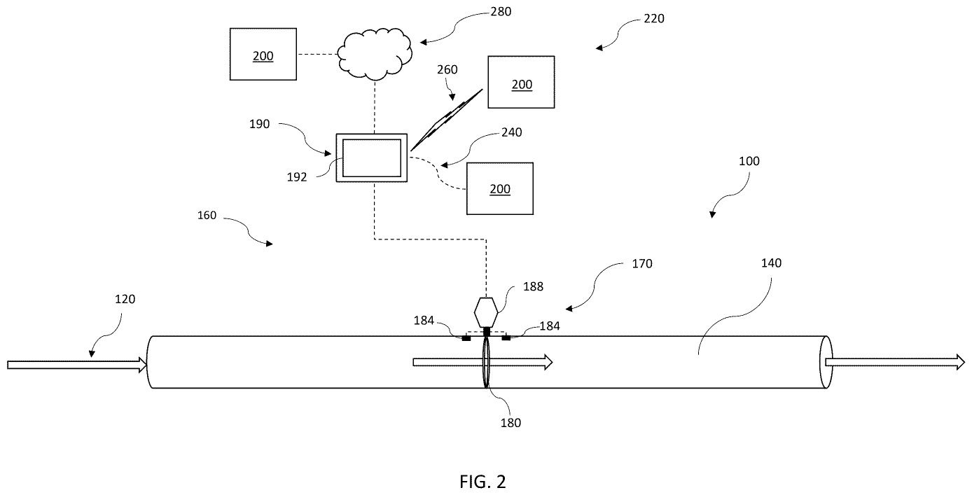

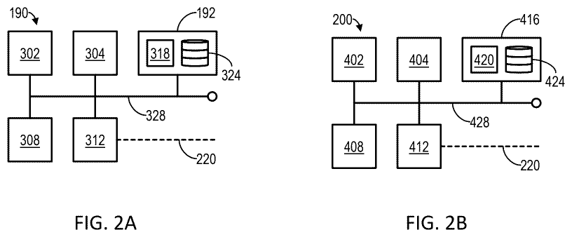

Turning to FIG. 2, the flow measurement computer 190 may communicate with one or more receiving computers 200 by one or more of a variety of data transfer pathways 220. In some embodiments, the flow measurement computer 190 and the receiving computer 200 are part of a Supervisory Control and Data Acquisition (SCADA) system. In some implementations, the flow measurement computer 190 and the receiving computer 200 are configured to operate within an industrial control system. In some implementations, a receiving computer 200 may be temporarily hard-wired to flow measurement computer 190 by means of a data cable 240. In another implementation, flow measurement computer 190 may communicate with receiving computer 200 by a telemetry pathway 260, such as by SCADA radio. In yet another implementation, flow measurement computer 190 may communicate with receiving computer 200 by means of a wired or wireless computer network 280, which may be a cloud network or other internet pathway. These methods are merely exemplary and it should be understood that other data transfer pathways 220 known to one of skill in the art are within the scope of this disclosure.

In general, the flow measurement computer 190 may securely transmit an auditable data set to a requesting party by utilizing private-public key cryptography algorithm. In this method, two “keys” are generated, which are a unique, fixed-length string of characters. One key may be a private key, which is stored on the flow measurement computer 190 and never shared or revealed to anyone. Another key may be a public key, which is stored on the flow measurement computer 190 but is sharable. The flow measurement computer 190 “signs” the data set with the private key by utilizing an algorithm such as a digital signature algorithm (DSA). The DSA may be an Elliptic Curve Digital Signature Algorithm (ECDSA). Though “DSA” is referred to herein, any public-key cryptographic algorithm or method may be used within the scope of this disclosure known to one of skill in the art, including but not limited to Rivest-Shamir-Adleman (“RSA”), Diffie-Hellman key exchange, and EIGamal encryption.

Signing the data set with a DSA generates a first “digital signature,” which may take any form such as another unique string of characters. The digital signature and public key, along with an identifier of the DSA utilized, are transmitted along with the data set to the receiving computer 200 of a requesting party. The processor 408 of the receiving computer 200 of the requesting party may then execute a digital verification algorithm (DVA) that may “sign”, i.e., verify, the data set with the public key using the DVA to generate a second digital signature, which may also take any form such as a string of characters. The first digital signature and second digital signature are compared. If the digital signatures match, the data set is verified as identical to the original data set on the flow measurement computer 190. If the first and second signatures do not match, the data set is not verified and exhibits some difference from the data set on the flow measurement computer 190. In this instance, the digital verification algorithm may cause the receiving computer 200 to generate an alert (e.g., a visual indication of successful or failed verification) when the first digital signature and the second digital signature are not identical and/or generate a log entry indicating a failure of the data verification when the first digital signature and the second digital signature are not identical. Stated another way, the processor 408 of the receiving computer 200 of the requesting party may execute a digital verification algorithm (DVA) that uses the public key, the received data set, and the received first digital signature as inputs. The processor 408 executing the DVA performs a computation to verify the validity of the first digital signature. If the first digital signature is valid, the data set is verified as authentic and unchanged from the original data set on the flow measurement computer 190. If the first digital signature is invalid, the data set is not verified. In some embodiments, the processor executable code when executed by the processor of the receiving computer is operable to cause the processor to store the verified flow measurement data set and the first digital signature on the non-transitory computer readable medium.

Referring now to FIG. 2A, shown therein is a block diagram of an exemplary embodiment of the flow measurement computer 190 of the custody transfer system 100 constructed in accordance with the present disclosure. In some embodiments, the flow measurement computer 190 may include, but is not limited to, implementation as a personal computer, a cellular telephone, a smart phone, a tablet, a laptop computer, a desktop computer, a network-capable handheld device, a server, a digital video recorder, and/or the like.

As shown in FIG. 2A, the flow measurement computer 190 generally includes one or more user input devices 302a-n (hereinafter, the “user input device 302”), one or more user output devices 304a-n (hereinafter, the “user output device 304”), one or more processors 308a-n (hereinafter, the “user processor 308”), one or more communication interfaces 312a-n (hereinafter, the “user communication interface 312”), and one or more non-transitory computer readable medium 192 storing one or more software applications 318a-n (hereinafter, the “user software application 318”) comprising processor-executable instructions and/or one or more user databases 324a-n (hereinafter, the “flow database 324”). The user input device 302, the user output device 304, the processor 308, the communication interface 312, and the non-transitory computer readable medium 192 may be connected via a flow path 328 such as a data bus that couples the components to permit communication among the components of the flow measurement computer 190.

The user input device 302 may be capable of receiving information input from the processor 308 and/or a user, and transmitting such information to other components of the flow measurement computer 190. The user input device 302 may include, but is not limited to, implementation as a keyboard, a touchscreen, a mouse, a trackball, a microphone, a camera, a fingerprint reader, an infrared port, an optical port, a cell phone, a smart phone, a Personal Digital Assistant (PDA), a remote control, a fax machine, a wearable communication interface, a network interface, combinations thereof, and/or the like, for example.

The user output device 304 may be capable of outputting information in a form perceivable by the processor 308 and/or a user. The user output device 304 may include, but is not limited to, implementation as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the user input device 302 and the user output device 304 may be implemented as a single device, such as, for example, a touchscreen of a computer, a tablet, or a smartphone. It is to be further understood that as used herein the term “user” is not limited to a human being, and may comprise a computer, a server, a website, a processor, a network interface, a user terminal, a virtual computer, combinations thereof, and/or the like, for example. The user output device 304 may display the user interface on the user input device 302.

The processor 308 may include, but is not limited to, implementation as a processor, a microprocessor, a mobile processor, a System on a Chip (SoC), a Central Processing Unit (CPU), a Microcontroller (MCU), a Digital Signal Processor (DSP), an Application Specific Integrated Circuit (ASIC), a Field Programmable Gate Array (FPGA), a Tensor Processing Unit (TPU), a Graphics Processing Unit (GPU), a combination of hardware and software, and/or the like. The processor 308 may be capable of communicating with the user input device 302, the user output device 304, the communication interface 312, and/or the non-transitory computer readable medium 192 via the flow path 328. Processor 308 may include one or more of the processor 308 working together or independently and located locally or remotely (e.g., accessible via the data transfer pathways 220).

The communication interface 312, in communication with the processor 308, may interface with the data transfer pathways 220. For example, the processor 308 may be capable of communicating via the data transfer pathways 220 by exchanging signals (e.g., analog, digital, optical, and/or the like) via one or more ports (e.g., physical or virtual ports) using a network protocol to communicate signals and/or data with the receiving computer 200.

The non-transitory computer readable medium 192 may store a software application 318 that, when executed by the processor 308, causes the processor 308 to perform an action such as “sign” the data set with the private key by utilizing an algorithm such as a digital signing algorithm (DSA). The software application 318 may include, for example, the digital signing algorithm.

The database 324 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The database 324 may be centralized or distributed across multiple systems.

Referring now to FIG. 2B, shown therein is a block diagram of an exemplary embodiment of the receiving computer 200 of the custody transfer system 100 constructed in accordance with the present disclosure. In some embodiments, the receiving computer 200 may include, but is not limited to, implementation as a personal computer, a cellular telephone, a smart phone, a network-capable television set, a tablet, a laptop computer, a desktop computer, a network-capable handheld device, a server, a digital video recorder, a wearable network-capable device, a VR/AR device, and/or the like.

As shown in FIG. 2B, the receiving computer 200 generally includes one or more input devices 402a-n (hereinafter, the “input device 402”), one or more output devices 404 a-n (hereinafter, the “output device 404”), one or more processors 408a-n (hereinafter, the “processor 408”), one or more communication interfaces 412a-n (hereinafter, the “communication interface 412”), and one or more non-transitory computer readable mediums 416 a-n (hereinafter, the “administrator memory 416”) storing one or more software applications 420 a-n (hereinafter, the “software application 420”) comprising processor-executable instructions and/or one or more databases 424 a-n(hereinafter, the “database 424”). The input device 402, the output device 404, the processor 408, the communication interface 412, and the non-transitory computer readable medium 416 may be connected via a path 428 such as a data bus that couples the components together to permit communication among the components of the receiving computer 200.

The input device 402 may be capable of receiving information input from the processor 408 and/or user, and transmitting such information to other components of the receiving computer 200 and/or data transfer pathways 220. The input device 402 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication interface, a network interface, combinations thereof, and/or the like, for example.

The output device 404 may be capable of outputting information in a form perceivable by the processor 408 and/or the user. The output device 404 may include, but is not limited to, implementation as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the input device 402 and the output device 404 may be implemented as a single device, such as, for example, a touchscreen of a computer, a tablet, or a smartphone. The output device 404 may display the user interface on the receiving computer 200.

The processor 408 may include, but is not limited to, implementation as a processor, a microprocessor, a mobile processor, an SoC, a CPU, an MCU, a DSP, an ASIC, an FPGA, a TPU, a GPU, a combination of hardware and software, and/or the like. The processor 408 may be capable of communicating with the input device 402, the output device 404, the communication interface 412, and/or the non-transitory computer readable medium 416 via the path 428. The processor 408 may include one or more of the processor 408 working together or independently and located locally or remotely (e.g., accessible via the data transfer pathways 220).

The communication interface 412, in communication with the processor 408, may interface with data transfer pathways 220 to communicate with the flow measurement computer 190. For example, the processor 408 may be capable of communicating via the data transfer pathways 220 by exchanging signals (e.g., analog, digital, optical, and/or the like) via one or more ports (e.g., physical or virtual ports) using a network protocol to communicate signals and/or data with the communication interface 312 of the flow measurement computer 190.

The non-transitory computer readable medium 416 may store the software application 420 that, when executed by the processor 408, causes the receiving computer 200 to perform an action such as execute the digital verification algorithm to determine the authenticity of the original data set.

The database 424 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. The data set received by the receiving computer 200 may be stored in the database 424. Also, the second digital signature generated by the digital verification algorithm may also be stored in the database 424.

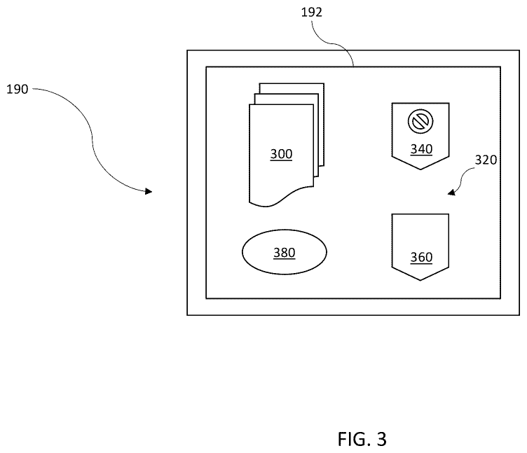

Turning to FIG. 3, the non-transitory computer readable medium 192 of flow measurement computer 190 may store flow measurement records 300 in the database 324. As noted above, flow measurement records 300 may take many forms but may be hourly records of flow measurement key data points. The non-transitory computer readable medium 192 of flow measurement computer 190 may further store a cryptographic key pair 320 comprising a private key 340 and public key 360. The non-transitory computer readable medium 192 of flow measurement computer 190 may further store cryptography software 380 which may be a DSA 380 having instructions for digitally signing flow measurement records 300 with cryptographic key pair 320. In some embodiments, the cryptography software 380 and/or the application 318 may be operable to maintain the private key on the flow measurement computer 190 in a manner which is inaccessible by the communication interface 312 so that the private key is not transferrable from the flow measurement computer 190.

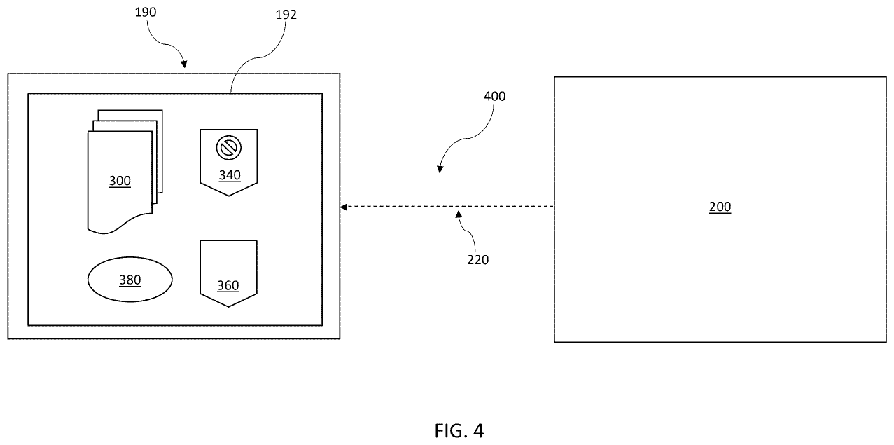

Turning to FIG. 4, the receiving computer 200 may transmit a request 400 for certain flow measurement records 300 to flow measurement computer 190. Request 400 may be transmitted by data transfer pathways 220. In some implementations, a request 400 may not be necessary, and flow measurement computer 190 may automatically and periodically transmit certain flow measurement records 300 to receiving computer 200.

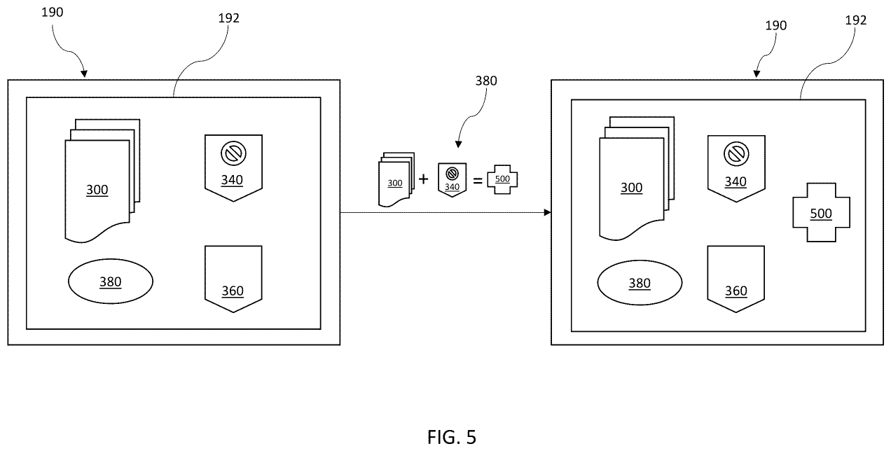

Turning to FIG. 5, flow measurement records 300 may be signed by private key 340 using DSA 380 to generate a first digital signature 500. The first digital signature 500 may be stored in non-transitory computer readable medium 192 of flow measurement computer 190. In some implementations, flow measurement computer 190 may automatically sign one or more collection of flow measurement records 300 as records are stored, such as by on-receipt, hourly, daily, weekly, or monthly. The first digital signature 500 generated for each collection of flow measurement records 300 may then be stored in non-transitory computer readable medium 192 along with the flow measurement records 300 for a period of time. In some implementations, hourly flow measurement records 300 and the first digital signatures 500 corresponding thereto may be kept for a period of thirty-five (35) days. In some implementations, the collection of flow measurement records 300 is a single measurement received by the flow measurement computer 190. In this implementation, upon receipt of the measurement, the flow measurement computer 190 digitally signs the measurement by private key 340 using DSA 380 to generate the first digital signature 500, and then stores the signed measurement and the private key 340 on the non-transitory computer readable medium 192. In another implementation, the flow measurement computer 190 may only digitally sign those flow measurement records 300 which are requested by the receiving computer 200.

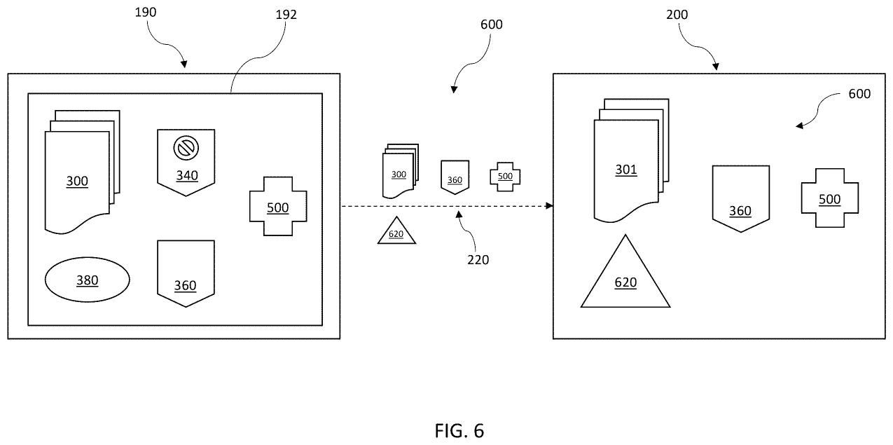

As shown in FIG. 6, flow measurement computer 190 may then transmit data package 600 by data transfer pathways 220 to receiving computer 200. In some implementations, data package 600 may be a readable data file such as a text file which is openable, readable, and editable by a wide variety of publicly available computer software. Data package 600 may also be an open-source file type. One exemplary file type may be a . txt file. Data package 600 may comprise readable data corresponding to flow measurement records 300, public key 360, first digital signature 500, and an identifier 620 of the particular DSA 380 that was used to generate first digital signature 500. Data package 600 may be stored on a memory within receiving computer 200. The flow measurement data 300 stored on receiving computer 200 may be referred to hereafter as “received flow measurement data 301”.

Turning to FIG. 7, received flow measurement data 301 may be stored on a receiving computer 200 purportedly corresponding to previously transmitted flow measurement data 300. Thus, it may be desired to verify the authenticity of received flow measurement data 301. To this end, public key 360, first digital signature 500, and DSA identifier 620 received with received flow measurement data 301 may be retrieved from the memory of receiving computer 200. Utilizing DSA 380, received flow measurement data 301 may be signed with public key 360 to generate a second digital signature 700. Second digital signature 700 may be stored in memory of receiving computer 200.

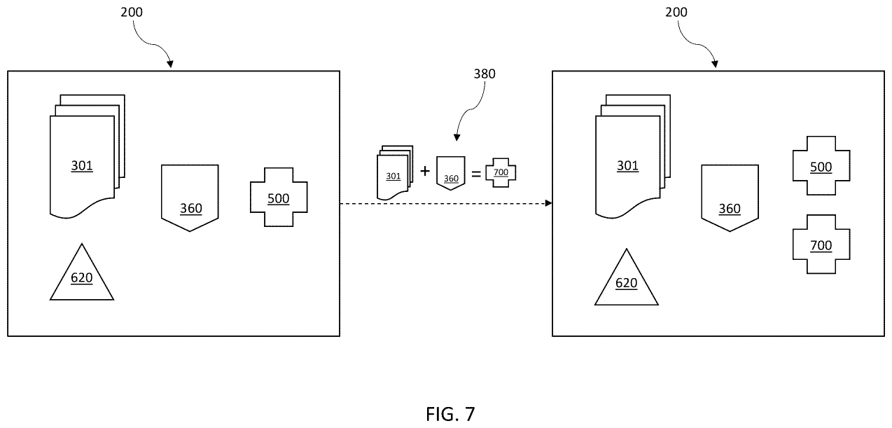

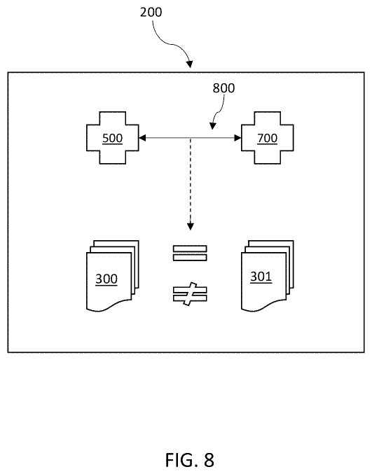

In the final step, shown in FIG. 8, first digital signature 500 and second digital signature 700 may be compared by a comparison method 800. Comparison method 800 may be any method suitable for evaluating whether or not the first digital signature 500 and second digital signature 700 are identical. Such methods 800 may include the processor 408 of the receiving computer 200 comparing the two signatures. If the first digital signature 500 and second digital signature 700 are identical, then the received flow measurement data 301 is verified as identical to the flow measurement data 300 signed by the flow measurement computer. If the first digital signature 500 and second digital signature 700 are not identical, the received flow measurement data 301 is not verified as identical to the flow measurement data 300 signed by the flow measurement computer.

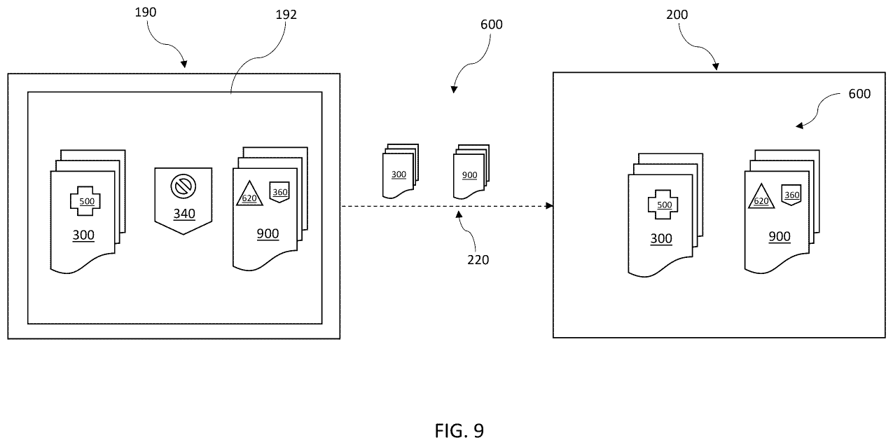

In some implementations, the public key 360, first digital signature 500, and DSA identifier 620 may be transmitted as separate data files, or as additional fields in existing data files. For example, as shown in FIG. 9, the flow measurement computer 190 may have stored on non-transitory computer readable medium 192 the flow measurement data 300 and a set of configuration data 900. Flow measurement data 300 may be typical flow measurement data but have an additional field with the digital signature 500. Similarly, configuration data 900 may exhibit typical configuration data but have two additional fields-one for DSA identifier 620 and one for public key 360. Then, data package 600 transmitted may comprise a flow measurement data set 300 and configuration data set 900 with these additional fields.

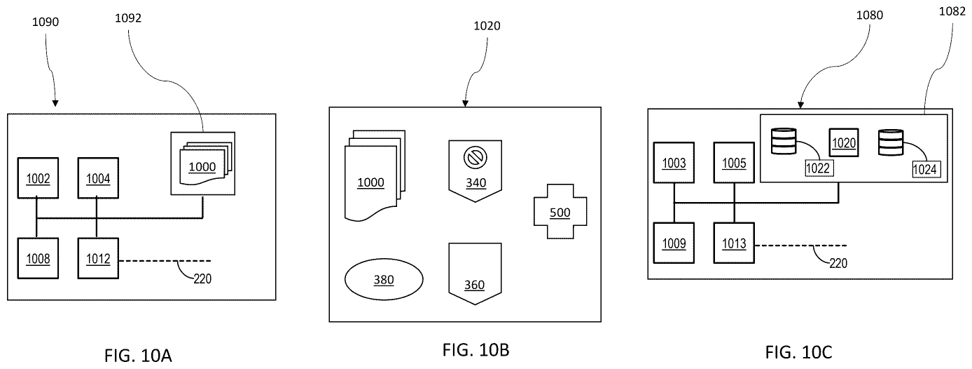

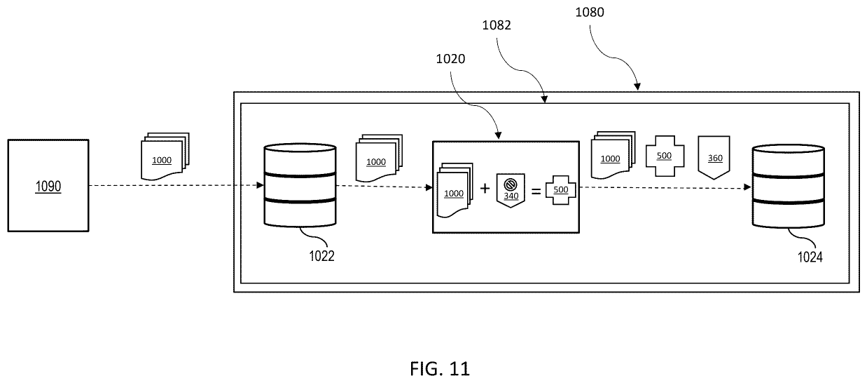

In some situations, to allow implementation of the present disclosure without significant changes to existing industrial infrastructure, signing functions similar to those carried out by the flow measurement computer 190 may be applied at a later point in the custody transfer chain of hydrocarbons, by another embodiment that receives as input an unsigned data flow and outputs signed data. This embodiment is illustrated by example in FIGS. 10A, 10B, 10C and 11. In this example flow measurement data 1000, from a digital data source, such as one or more existing flow measurement computers 1090 lacking the ability to sign flow measurement data, is signed remotely by a signatory computer 1080 in accordance with the embodiment. This embodiment allows the signing of flow measurement data 1000 without having to modify flow measurement computers 1090.

Turning to FIG. 10A, the following is an example of an unmodified flow measurement computer 1090 lacking the ability to sign flow measurement data as is known in the art. The flow measurement computer 1090 generally includes one or more input devices 1002a-n (hereinafter, the “input device 1002”), one or more output devices 1004a-n (hereinafter, the “output device 1004”), one or more processors 1008a-n (hereinafter, the “processor 1008”), one or more communication interfaces 1012a-n (hereinafter, the “communication interface 1012”). The communication interface 1012, in communication with the processor 1008, may interface with the data transfer pathways 220.

The flow measurement computer 1090 may have stored on the non-transitory computer readable medium 1092 the unsigned electronic flow measurement (EFM) data 1000. EFM data 1000 may be typical flow measurement data but said EFM data 1000 does not have an associated digital signature. In this example, the non-transitory computer readable medium 1092 also stores computer readable instructions for communicating the unsigned electronic flow measurement data 1000 to a signatory computer 1080 shown in FIG. 10C and FIG. 11. The computer readable instructions may include an electronic address uniquely identifying the signatory computer 1080 as well one or more parameters utilized by the processor 1008 for communicating the EFM data 1000 to the signatory computer 1080 via the communication interface 1012. For example, the one or more parameters may include a schedule for communicating the EFM data 1000 to the signatory computer and/or a desired format for the EFM data 1000. In some embodiments, once the parameters are selected and/or stored on the non-transitory computer readable medium 1092, the processor 1008 will follow the parameters in transmitting the EFM data 1000 to the signatory computer 1080 via the communication interface 1012.

Turning to FIG. 10B, the following example is an illustration of an application 1020 that signs EFM data 1000 using a DSA 380. Within the application 1020, the EMF data 1000 may be signed by private key 340 using DSA 380 to generate a first digital signature 500. The first digital signature 500 generated for each collection of EFM data 1000 may then be stored in non-transitory computer readable medium 1082 (FIG. 10C and FIG. 11) along with the EMF data 1000 for a period of time, such as minutes, hours, days, weeks, or the like.

Turning to FIG. 10C, the following is an example of the signatory computer 1080 that carries out the procedure of signing unsigned EMF data 1000. The signatory computer 1080 generally includes one or more input devices 1003a-n (hereinafter, the “input device 1003”), one or more output devices 1005a-n (hereinafter, the “output device 1005”), one or more processors 1009a-n (hereinafter, the “processor 1009”), one or more communication interfaces 1013a-n (hereinafter, the “communication interface 1012”). The communication interface 1013, in communication with the processor 1009, may interface with the data transfer pathways 220.

The signatory computer 1080 contains the non-transitory computer-readable medium 1082, which in turn contains a temporary database 1022 where unsigned EFM data 1000 is initially stored, the signing application 1020 to sign unsigned EFM data 1000, and a permanent database 1024 for the long-term storage of signed data for the purpose of auditing. Those of skill in the art will note that the signing procedure could be carried out by more than one computer, a networked computer, or another configuration of a computer system.

Turning to FIG. 11, the following is an example of a method for signing the EMF data 1000. In some embodiments, the flow measurement computer 1090 lacks the ability to digitally sign the EMF data 1000. In this instance, the EMF data 1000 is converted to digitally signed and verifiable data by the present disclosure remotely from the flow measurement computer 1090. Electronic flow management (EFM) data 1000 is transmitted by an unmodified flow measurement computer 1090, and received by the signatory computer 1080. The EFM data 1000 is transmitted, via radio or other network communication link, using communication software and a communication protocol (i.e. Autosol, Kepware, etc.), to a temporary database 1022 stored in the non-transitory computer readable medium 1082 and accessible by the signatory computer 1080. In some embodiments, the signatory computer 1080 hosts the temporary database 1022. The software application 1020 digitally signs the EMF data 1000 to create signed data, and then stores the signed data in a system database 1024, said system database 1024 is stored in the non-transitory computer readable medium and may be hosted by the signatory computer 1080. Signing the EMF data 1000 comprises generating, by the DSA 380, the first digital signature 500 associated with the EMF data 1000 utilizing the private key 340 as previously described. The EMF data 1000 and associated digital signature 500 are then stored in the system database 1024 to confirm and preserve auditability. The software application 1020 and database 1024 may also be housed in the non-transitory computer readable medium 1082 of the signatory computer 1080. The EFM data 1000 and its signature 500 may be stored in the system database 1024, along with the associated public key 360 for verification. The signed data may later be retransmitted, shared and verified by the receiving computer 200 utilizing the various teachings of the present disclosure. In some embodiments, the teachings of this paragraph allow the disclosure to be utilized without having to modify existing flow measurement computers.

### CONCLUSION

A system and method for flow measurement data transfer and verification are disclosed. A flow measurement computer may sign a flow measurement data set with a private key using a digital signature algorithm to generate a digital signature. The flow measurement computer may transmit the data set, a public key corresponding to the private key, and the digital signature to a receiving computer. Using the public key and digital signature algorithm, the receiving computer may sign the flow measurement data set to generate a new digital signature. If the new digital signature matches the original digital signature, the flow measurement data set is verified as authentic.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

What is claimed is:

1. A system, comprising:
a flow measurement computer configured to:
generate a flow measurement data set; and
generate a first digital signature by digitally signing the flow measurement data set with a private key using a digital signature algorithm; and
incorporate a public key based on the private key and the digital signature algorithm into the flow measurement data set; and
a receiving computer configured to:
receive the flow measurement data set and the first digital signature;
generate a second digital signature by digitally signing the received flow measurement data set with the public key corresponding to the private key, using the same digital signature algorithm; and
compare the first digital signature to the second digital signature, wherein the received flow measurement data set is verified as authentic when the first digital signature and the second digital signature match.

2. The system of claim 1, wherein the digital signature algorithm is a public-key cryptography algorithm.

3. The system of claim 1, wherein the flow measurement computer is further configured to transmit the public key to the receiving computer.

4. The system of claim 1, wherein the flow measurement data set includes at least one of: flow rate, pressure, temperature, or density.

5. The system of claim 1, wherein the flow measurement computer and the receiving computer are configured to operate within an industrial control system.

6. The system of claim 1, wherein the receiving computer is further configured to generate an alert when the first digital signature and the second digital signature do not match.

7. A method, comprising:
generating, by a flow measurement computer, a flow measurement data set;
generating, by the flow measurement computer, a first digital signature and a public key by digitally signing the flow measurement data set with a private key using a digital signature algorithm;
transmitting the flow measurement data set, the public key and the first digital signature from the flow measurement computer to a receiving computer;
generating, by the receiving computer, a second digital signature by digitally signing the received flow measurement data set with the public key corresponding to the private key, using the same digital signature algorithm; and
comparing, by the receiving computer, the first digital signature to the second digital signature, wherein the flow measurement data set received by the receiving computer is verified as authentic when the first digital signature and the second digital signature match.

8. The method of claim 7, wherein the digital signature algorithm is an Elliptic Curve Digital Signature Algorithm (ECDSA).

9. The method of claim 7, wherein the flow measurement data set comprises a time-stamped series of flow rate measurements.

10. The method of claim 7, wherein the flow measurement computer and the receiving computer are part of a Supervisory Control and Data Acquisition (SCADA) system.

11. The method of claim 7, further comprising generating a log entry indicating a failure of the data verification when the first digital signature and the second digital signature do not match.

12. A receiving computer, comprising:
a communication interface configured to receive a flow measurement data set and a first digital signature, wherein the first digital signature is generated by a flow measurement computer signing the flow measurement data set with a private key using a digital signature algorithm;
a processor coupled to a non-transitory computer readable medium storing processor executable code operable to:
generate a second digital signature by signing the received flow measurement data set with a public key corresponding to the private key, using the same digital signature algorithm; and
compare the first digital signature to the second digital signature, wherein the received flow measurement data set is verified as authentic when the first digital signature and the second digital signature match.

13. The receiving computer of claim 12, wherein the communication interface is configured to receive the public key along with the flow measurement data set and the first digital signature.

14. The receiving computer of claim 12, wherein the flow measurement data set includes a unique identifier associated with a specific flow meter.

15. The receiving computer of claim 12, wherein the processor executable code when executed by the processor is operable to cause the processor to provide a visual indication of successful or failed verification.

16. The receiving computer of claim 12, wherein the processor executable code when executed by the processor is operable to cause the processor to store the verified flow measurement data set and the first digital signature on the non-transitory computer readable medium.

17. A system, comprising:
a non-transitory computer readable medium storing a digital signature algorithm including a key pairing comprising a private key for signing data and a public key;
a flow measurement computer configured to:
generate a flow measurement data set; and
generate a digital signature by digitally signing the flow measurement data set with the private key using the digital signature algorithm; and
incorporate the public key and an identifier of the digital signature algorithm into the flow measurement data set; and
a receiving computer configured to:
receive the flow measurement data set and the digital signature and the public key;
apply the public key to the digital signature, wherein the received flow measurement data set is verified as authentic when the public key verifies the digital signature.

18. A receiving computer, comprising:
a communication interface configured to receive a flow measurement data set and a digital signature, wherein the digital signature is generated by a flow measurement computer signing the flow measurement data set with a private key using a digital signature algorithm;
a processor coupled to a non-transitory computer readable medium storing processor executable code operable to:
receive the flow measurement data set and a public key corresponding to the private key; and
validate the digital signature with the digital signature algorithm and the public key.

19. A system comprising:
a digital data source providing flow measurement data, the digital data source comprising a physical communication interface configured to transmit the flow measurement data, the flow measurement data representing one or more measurements of one or more flows of hydrocarbons;
a signatory computer comprising a non-transitory computer-readable medium, a processor, and a communication interface, configured to receive the flow measurement data transmitted by the digital data source, the non-transitory computer readable medium storing instructions that when executed by the processor cause the processor to:
utilize a digital signature algorithm (DSA) to create a unique digital signature by applying the DSA and a private key to the flow measurement data;
store the flow measurement data, the unique digital signature, and the public key in a database; and
provide the flow measurement data, signature, and public key in response to a request for verification of the flow measurement data.
